(19) United States
(12) Patent Application Publication
(10) Pub. No.: US 2025/0284533 A1
(43) Pub. Date: Sep. 11, 2025

(54) METHOD AND SYSTEM FOR IDENTIFYING MIGRATION APPROACH FOR A MONOLITH APPLICATION

(71) Applicant: HCL Technologies Limited, NEW DELHI (IN)

(72) Inventors: Hareendran M, Chennai (IN); Maheswari V.S, Chennai (IN); Gayathri Ganeshan, Chennai (IN)

(21) Appl. No.: 19/074,328

(22) Filed: Mar. 8, 2025

(30) Foreign Application Priority Data
Mar. 11, 2024 (IN) 202411017383

(51) Int. Cl. G06F 9/48; G06F 9/455

(52) U.S. Cl. CPC G06F 9/4856; G06F 9/45558; G06F 2009/4557

(57) ABSTRACT

The disclosure relates to a method and system of identifying migration approach for a monolith application is disclosed. The method includes obtaining a set of characteristic values corresponding to an associated parameters value, and determining a consolidated characteristic value, by combining a plurality of characteristic values corresponding to the plurality of parameters along with a corresponding respective weightage. The method further includes obtaining an associated affinity-priority value and an associated affinity-weightage value corresponding to an associated parameters value, and calculating a migration score based on the consolidated characteristic value, the associated priority value, and associated affinity weightage value, and selecting a relevant migration approach from the set of migration approaches, based on the migration score for each of the set of migration approaches.

### TECHNICAL FIELD

This disclosure relates generally to cloud migration, and in particular to a method and a system for identifying migration approach for migration of a monolith application.

### BACKGROUND

Digitization and migration of applications (in particular, monolith applications) to cloud is key to the success for any business to avail the advantages of latest technologies and flexibility of cloud environment. A monolith application is a software architecture where all the components and functionalities of the application are tightly integrated into a single codebase and executed as a single unit. In other words, monolith application is a traditional, unified, and often large-scale software application where the server-side and client-side components are bundled together. Though the pace of cloud migration has increased, however, major percentage of the applications are still on-premises. As such, there exist may challenges with respect to migration of the monolith applications, including challenges in selecting the right approach based on the nature of application, business continuity with minimal downtime, and risk associated with migration complexity, cost, and time.

Some existing techniques suggest migration approaches based on consideration of multiple factors. However, there is no defined way to automatically identify the characteristics of the application corresponding to these factors. Also, the influences of these characteristics in the decision-making process might be in conflicting directions that these techniques. Further, interdependencies of characteristics might also influence the approach selection that the existing techniques do not take in to account.

Therefore, there is a need for solutions that overcome the above challenges, and provide effective and efficient ways of identifying migration approach for migration of a monolith application.

### SUMMARY

In an embodiment, a method of identifying migration approach for a monolith application is disclosed. The method may include, for each of a plurality of parameters associated with the monolith application, and for a set of characteristics, obtaining a set of characteristic values corresponding to an associated parameters value. The associated parameters value corresponding to the associated parameters value may be predetermined. The method may further include, for each characteristic of the set of characteristics, determining a consolidated characteristic value, by combining a plurality of characteristic values corresponding to the plurality of parameters along with a corresponding respective weightage. The method may further include, for each of the plurality of parameters associated with the monolith application, and for each characteristic of the set of characteristics, obtaining an associated affinity-priority value and an associated affinity-weightage value corresponding to an associated parameters value. The associated affinity-priority value and the affinity-associated affinity weightage value corresponding to the associated parameters value may be predetermined. The method may further include, for each of a set of migration approaches, calculating a migration score based on the consolidated characteristic value, the associated priority value, and associated affinity weightage value, and selecting a relevant migration approach from the set of migration approaches, based on the migration score for each of the set of migration approaches.

In another embodiment, a system for identifying migration approach for a monolith application is disclosed. The system includes a processor and a memory communicatively coupled to the processor. The memory storing a plurality of processor-executable instructions, which upon execution by the processor, cause the processor to, for each of a plurality of parameters associated with the monolith application, and for a set of characteristics, obtain a set of characteristic values corresponding to an associated parameters value. The associated parameters value corresponding to the associated parameters value may be predetermined. The plurality of processor-executable instructions further cause the processor to, for each characteristic of the set of characteristics, determine a consolidated characteristic value, by combining a plurality of characteristic values corresponding to the plurality of parameters along with a corresponding respective weightage. The plurality of processor-executable instructions further cause the processor to, for each of the plurality of parameters associated with the monolith application, and for each characteristic of the set of characteristics, obtain an associated affinity-priority value and an associated affinity-weightage value corresponding to an associated parameters value. The associated affinity-priority value and the affinity-associated affinity weightage value corresponding to the associated parameters value may be predetermined. The plurality of processor-executable instructions further cause the processor to, for each of a set of migration approaches, calculate a migration score based on the consolidated characteristic value, the associated priority value, and associated affinity weightage value, and select a relevant migration approach from the set of migration approaches, based on the migration score for each of the set of migration approaches.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for identifying migration approach for a monolith application, in accordance with some embodiments of the present disclosure.

FIG. 2 is a block diagram of an approach identifying device of the system of FIG. 1 showing one or more modules, in accordance with some embodiments.

FIG. 3 is a Table-1 showing example characteristics and their associated characteristics values for a parameter “LoC size of the Application”, in accordance with some embodiments.

FIG. 4 is a Table-2 showing example parameters and their associated parameters values for a characteristic “application size and complexity”, in accordance with some embodiments.

FIG. 5 is a Table-3 showing a plurality of characteristic values corresponding to the plurality of parameters for a characteristic “Application Size and complexity”, in accordance with some embodiments.

FIG. 6 is a Table-4 showing a plurality of characteristics and their consolidated score as calculated, in accordance with some embodiments.

FIG. 7 is a Table-5 showing an example characteristics dependency matrix, in accordance with some embodiments.

FIG. 8 is a Table-6 showing plurality of characteristics and their refined consolidated score, in accordance with some embodiments.

FIG. 9 is a Table-7 showing example affinity scores to the different migration approaches for the characteristic “size and complexity of application”, in accordance with some embodiments.

FIG. 10 is a Table-8 showing example migration approach scores for different characteristics for a given application, in accordance with some embodiments.

FIG. 11 is a Table-9 showing a level of impact on the migration approach and weightage for that migration approach for each parameter, in accordance with some embodiments.

FIG. 12 is a Table-10 showing refined approach score for the application for all the migration approaches, in accordance with some embodiments.

FIG. 13 is a Table-11 showing an order approach, in accordance with some embodiments.

FIG. 14 is a flowchart of a method of identifying migration approach for a monolith application, in accordance with some embodiments.

FIG. 15 is an exemplary computing system that may be employed to implement processing functionality for various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

A method and system for identifying migration approach for a monolith application are disclosed. The migration approach may be selected from one or more possible migration approaches, based on a low risk and optimized migration strategy for the monolith application through multi-dimensional analysis. The possible migration approaches may include:
“Retain” migration approach: where there is no movement of the application to cloud, and the application is retained in its current environment;
“Re-Host” migration approach: where the application is moved to cloud with minor or no changes;
“Re-Platform” migration approach: the application is upgraded to work better in the cloud environment. This may include modernizing the application by addressing any cloud native issues or upgrading the technology stack of the application that better suite the cloud environment.
“Re-Factor” migration approach: the application is decomposed into small, easily manageable functional modules. The functional modules are modernized to leverage the maximum advantage of cloud. The target functional module architecture may be based on the nature of the functional module and its business criticality like microservice, serverless function, standalone app etc.
“Re-write” migration approach: the functional modules are developed from scratch, using application insights.
“Hybrid” migration approach: a combination of the above-mentioned different approaches. For example, in case of a monolith application which has multiple functional modules, some of the modules may be considered for “re-factor” migration approach and some may considered for “re-write” migration approach.

It should be noted that multiple factors (i.e. parameters) related to application characteristics and business priorities may be considered for selecting the right migration approach. For example, these factors (parameters) may include: “application data complexity”, “external dependency of application”, “application size and complexity”, “legacy platform dependency”, “legacy technology dependency”, “cloud readiness issues of application”, “business logic reusability”, “scale or performance improvement requirement”, “openness to modernization and new technologies adoption”, “application future life”, “business criticality of application”, “time factor”, and “cost factor”.

An objective of the present disclosure is to propose a unique framework to identify key characteristics of the application through multi-dimensional analysis. Another objective of the present disclosure is to derive affinity of the application towards the possible migration approaches considering the conflicting interdependencies of the application and business characteristics. Yet another objective of the present disclosure is to derive the best fit approach for migration. To this end, the methodology of selecting the migration approach includes one or more steps.

The one or more steps include collecting data related to the functionality, technical, business, non-functional requirement, and policy level of the application. In order to collect data, a tool-based automated data collection technique may be used. Alternatively or additionally, data may be collected based on inputs received from the stakeholders (enterprises linked with the monolith application). The one or more steps further include analyzing the collected data to derive values for the defined set of parameters, determining priority of the parameters and weightage of the value, and determining level of influence of the values in deciding the application characteristics. Further, the one or more steps include deriving application characteristics by consolidating applicable values, refining the application characteristic value through characteristics inter-dependency analysis, defining the influence of characteristics in migration approach selection, and determining migration approach affinity score corresponds to the application characteristics. Furthermore, the one or more steps include deriving migration approach scores, refining the migration approach scores for the directly influencing parameters or characteristics, and finding the best fit migration approach.

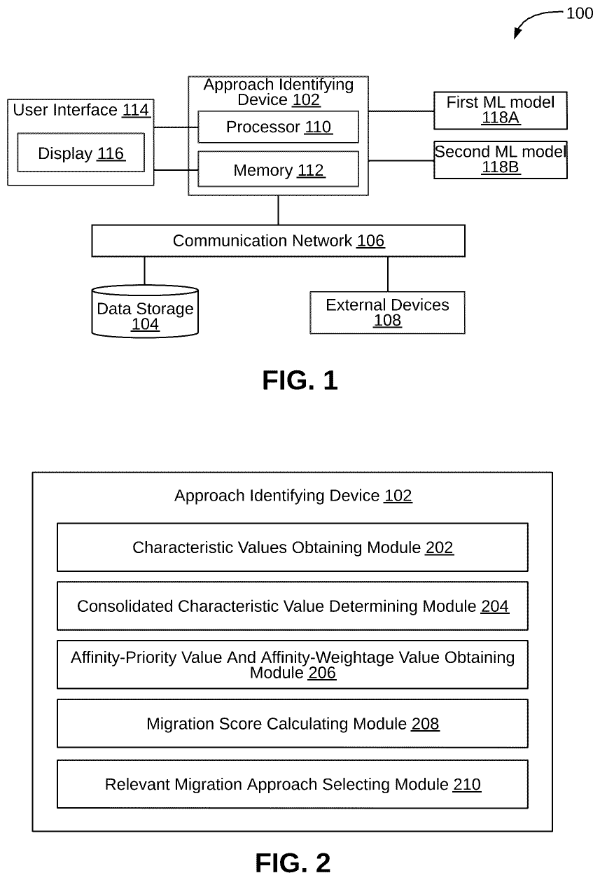

Referring now to FIG. 1, a block diagram of an exemplary system 100 for identifying migration approach for a monolith application is illustrated, in accordance with some embodiments of the present disclosure. The system 100 may implement an approach identifying device 102. Further, the system 100 may include a data storage 104. In some embodiments, the data storage 104 may store at least some of the data related to the monolith application. The approach identifying device 102 may be a computing device having data processing capability. In particular, the approach identifying device 102 may have the capability for selecting a relevant migration approach from the set of migration approaches, based on the migration score for each of the set of migration approaches. Examples of the approach identifying device 102 may include, but are not limited to a desktop, a laptop, a notebook, a netbook, a tablet, a smartphone, a mobile phone, an application server, a web server, or the like.

Additionally, the approach identifying device 102 may be communicatively coupled to an external device 108 for sending and receiving various data. Examples of the external device 108 may include, but are not limited to, a remote server, digital devices, and a computer system. The approach identifying device 102 may connect to the external device 108 over a communication network 106. The approach identifying device 102 may connect to external device 108 via a wired connection, for example via Universal Serial Bus (USB). A computing device, a smartphone, a mobile device, a laptop, a smartwatch, a personal digital assistant (PDA), an e-reader, and a tablet are all examples of external devices 108. For example, the communication network 120 may be a wireless network, a wired network, a cellular network, a Code Division Multiple Access (CDMA) network, a Global System for Mobile Communication (GSM) network, a Long-Term Evolution (LTE) network, a Universal Mobile Telecommunications System (UMTS) network, a Worldwide Interoperability for Microwave Access (WiMAX) network, a Dedicated Short-Range Communications (DSRC) network, a local area network, a wide area network, the Internet, satellite or any other appropriate network required for communication between the approach identifying device 102 and the data storage 104 and the external device 108.

The approach identifying device 102 may be configured to perform one or more functionalities that may include, for each of a plurality of parameters associated with the monolith application, and for a set of characteristics, obtaining a set of characteristic values corresponding to an associated parameters value. The associated parameters value corresponding to the associated parameters value may be predetermined. The one or more functionalities may further include, for each characteristic of the set of characteristics, determining a consolidated characteristic value, by combining a plurality of characteristic values corresponding to the plurality of parameters along with a corresponding respective weightage. The one or more functionalities may further include, for each of the plurality of parameters associated with the monolith application, and for each characteristic of the set of characteristics, obtaining an associated affinity-priority value and an associated affinity-weightage value corresponding to an associated parameters value. The associated affinity-priority value and the affinity-associated affinity weightage value corresponding to the associated parameters value may be predetermined. The one or more functionalities may further include, for each of a set of migration approaches, calculating a migration score based on the consolidated characteristic value, the associated priority value, and associated affinity weightage value, and selecting a relevant migration approach from the set of migration approaches, based on the migration score for each of the set of migration approaches.

To perform the above functionalities, the approach identifying device 102 may include a processor 110 and a memory 112. The memory 112 may be communicatively coupled to the processor 110. The memory 112 stores a plurality of instructions, which upon execution by the processor 110, cause the processor 110 to perform the above functionalities. The system 100 may further include a user interface 114 which may further implement a display 116. Examples may include, but are not limited to a display, keypad, microphone, audio speakers, vibrating motor, LED lights, etc. The user interface 114 may receive input from a user and also display an output of the computation performed by the approach identifying device 102.

Referring now to FIG. 2, a block diagram of the approach identifying device 102 showing one or more modules is illustrated, in accordance with some embodiments. In some embodiments, the approach identifying device 102 may include a characteristic value obtaining module 202, a consolidated characteristic value determining module 204, an affinity-priority value and affinity-weightage value obtaining module 206, a migration score calculating module 208, and a relevant migration approach selecting module 210.

The characteristic value obtaining module 202 may be configured to obtaining a set of characteristic values corresponding to an associated parameters value, for each of a plurality of parameters associated with the monolith application, and for a set of characteristics. The associated parameters value corresponding to the associated parameters value may be predetermined, based on data associated with the monolith application. For example, the data may be collected corresponding to business objective and business context data, (monolith) application landscape, technology landscape, security and compliance related data, and non-functional requirements (NFR) related data. In some embodiments, the data may be collected via one or more of data collection techniques. For example, in one of the techniques, the data may be collected using automated and tool-based approaches. Alternatively, the data may be collected product documents. Further, in some cases, the data may be collected based on interviews, discussions, or sessions conducted with stakeholders (i.e. enterprises).

Once the data is collected, the collected data may be analyzed to derive the values for parameters that influence identifications of the monolith application's characteristics that are relevant for selection of migration approach. For example, the different categories corresponding to the parameters may include a business context category, an application landscape category, a technology landscape category, and NFR details. In particular, the business context category may relate to parameters that can be used to understand the business criticality of the monolith application. The application landscape category may be related to application level metrices of the monolith application, including nature of the application, sizing details, etc. the technology landscape category may be related to technology and frameworks used in the monolith application. The NFR details may relate to details including scalability requirements, performance requirements, compliance requirements, etc.

Therefore, the characteristic value obtaining module 202 may obtain a set of characteristic values corresponding to an associated parameter value, for each of a plurality of parameters associated with the monolith application, and for a set of characteristics. In some embodiments, in order to obtain the parameter value, the characteristic value obtaining module 202 may analyze (for example, based on questions and answers during data collection) attribute data associated with the monolith application, and determine the associated parameters value based on the analyzing. In particular, determining the associated parameters value may include selecting a relevant associated parameter value from a plurality of selectable associated parameters values, based on the analyzing.

For example, the parameter may be “Lines of code (LoC) size of application”; and the characteristics corresponding to the parameter may include “application data complexity”, “external dependency of application”, “application size and complexity”, “legacy platform dependency”, “legacy technology dependency”, “cloud readiness issues of application”, “business logic reusability”, “scale or performance improvement requirement”, “openness to modernization and new technologies adoption”, “application future life”, “business criticality of application”, “time factor”, and “cost factor”.

In some embodiments, prior to obtaining the set of characteristic values corresponding to an associated parameter value, priority of the parameters may be determined. Priory of the parameters may vary based on the type of application and the context of the business. For example, for some applications, the business criticality may be of high priority, and other applications, performance may be of high priority. If priority of a parameter is high in a particular business context, the value to that parameter may have higher influence in deciding the characteristics associated with the application. Further, weightage of the values to the parameters may be a factor in deriving the characteristic values. For example, for a parameter corresponding to a question: “what is the expected future life of the application?”, if the answer (value) is “very low”, then the parameter may be assigned a high weightage. This is because if the expected future life is “very low”, then irrespective of the characteristics of the application, recommended approach would be “Retain”. Similarly, if the value of the parameter is assigned as “High”, weightage would be low because recommended approach would be based on other characteristics of the application. The priority and weightage may be determined for each question (for data collection). In an example implementation, the priority and weightage may be determined based on industrial standard; however, this may be overridden according to the business context. As such, the parameter “expected future life of the application” may be assigned a priority P1; and corresponding to the probable parameter values “very high”, “high”, “medium”, and “low”, the weightage assigned may be “w1”, “w2”, “w3”, and “w4”, respectively. Depending on the analysis of the attributes data associated with the monolith application, one of the parameter values “very high”, “high”, “medium”, and “low”, and the corresponding weightage “w1”, “w2”, “w3”, and “w4” may be selected.

As will be appreciated by those skilled in the art, all the answers to the questions (during data collection) may not influence all the characteristics of the application. Further, levels of influence of answers on the characteristics may vary as well. For example, for deciding the characteristic “size and complexity” of the applications”,
the questions “what is the expected future life of the application?” may not have any role;
the question “what is Line of Code (LoC) of the application?” may have a role with level of influence “High”; and
the question “what is the application architecture type” may have a role with level of influence “Low”.

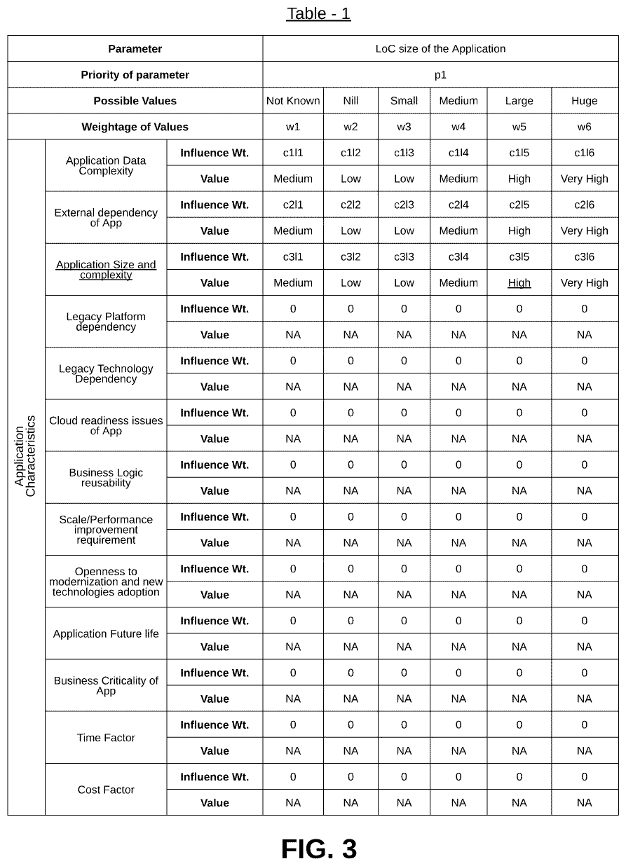

Accordingly, for each parameter, the dependent application characteristics and the level of influence may be determined. Some example characteristics and their associated characteristics values for a parameter “LoC size of the Application” are collated in Table-1 illustrated in FIG. 3. For example, with reference to Table-1 (FIG. 3) associated with the parameter “LoC size of the Application”, for the characteristic “application size and complexity” (underscored in Table-1), the parameter “LoC size of the application” may have “High” value (underscored).

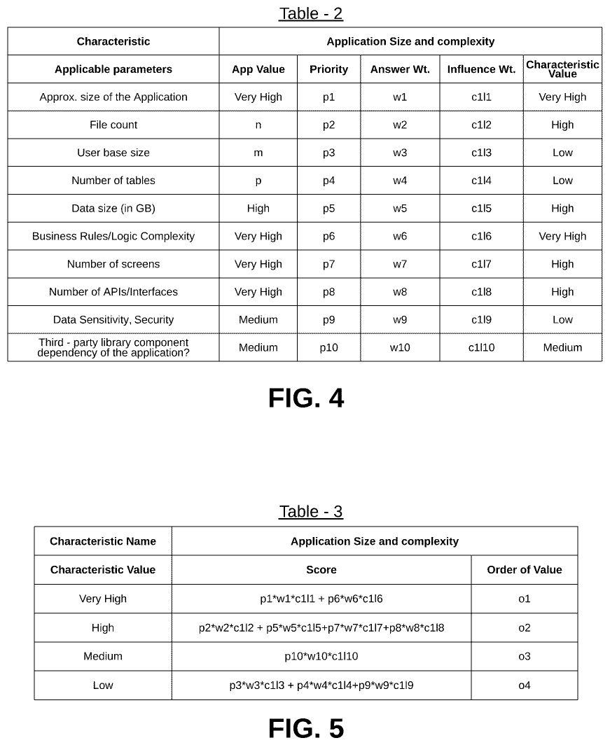

The characteristic value obtaining module 202 may further perform a characteristic driven analysis to identify all applicable parameters and associated values along with the level of influence. Some example parameters their associated parameters values for a characteristic “application size and complexity” are collated in Table-2 illustrated in FIG. 4. Accordingly, for each of the plurality of parameters associated with the monolith application and for the set of characteristics, the characteristic value obtaining module 202 may obtain a set of characteristic values corresponding to an associated parameters value.

The consolidated characteristic value determining module 204 may be configured to determine a consolidated characteristic value, for each characteristic of the set of characteristics, by combining a plurality of characteristic values corresponding to the plurality of parameters along with a corresponding respective weightage. In some embodiments, the consolidated characteristic value determining module 204 may group the characteristic based on the “characteristic value” and identify the consolidated weightage of each characteristic value.

As such, to determine the consolidated characteristic value, the consolidated characteristic value determining module 204 may group together one or more characteristics from the set of characteristics into a plurality of groups based on the set of characteristic values. Further, for each group of the plurality of groups, the consolidated characteristic value determining module 204 may determine a consolidated group characteristic value, by combining characteristic values corresponding to the characteristics associated with the group, along with corresponding respective characteristic-weightages, to further determine an order value.

For the characteristic “Application Size and complexity”, Table-3 illustrated in FIG. 5 shows a plurality of characteristic values (“very high”, “high”, “medium”, and “low”) corresponding to the plurality of parameters. Further, the Table-3 shows characteristic value (“score”) for each of the plurality of characteristic values. For example, with reference to FIG. 4, the characteristics “Approx. size of the Application” and “Business Rules/Logic Complexity”, each having characteristic score “very high” are grouped together. Further, a consolidated score is calculated for the said characteristics having characteristic score “very high” as a product of “priority”, “answer weightage”, and “influence weightage” (as shown in Table-2); therefore, the consolidated score is calculated as (p1*w1*c111+p6*w6*c116). Similar exercise may be performed for all the other characteristics having the characteristic value “high”, “medium”, and “low”.

As further shown in Table-3, in some embodiments, an order for the characteristic value may be determined, as below:

$$Order of final Characteristic value = sum ( score * order ) / sum ( score )$$

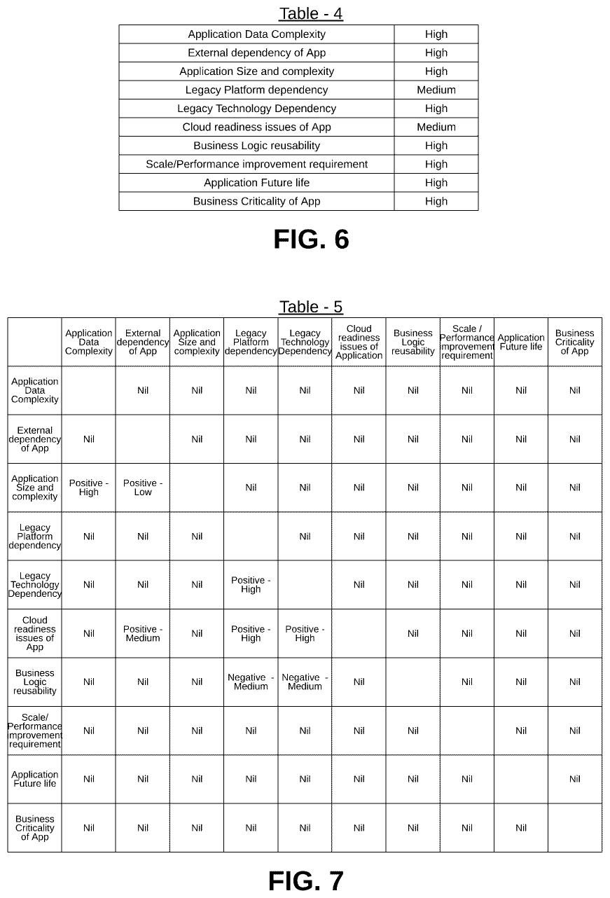

Further, based on the order, the associated characteristic value may be identified for a given characteristic. Similarly, for each characteristic, based on the priority and weightage of the applicable answers, the characteristic value may be determined. The plurality of characteristics and their consolidated score as calculated are collated in Table-4 illustrated in FIG. 6. As such, the plurality of characteristics may include “application data complexity”, “external dependency of application”, “application size and complexity”, “legacy platform dependency”, “legacy technology dependency”, “cloud readiness issues of application”, “business logic reusability”, “scale or performance improvement requirement”, “openness to modernization and new technologies adoption”, “application future life”, and “business criticality of application”.

In some embodiments, the consolidated characteristic value determining module 204 may be configured to refine the consolidated characteristic value (for each characteristic of the set of characteristics) based on an inter-relationship of the characteristic with remaining of the set of characteristics, to obtain a refined consolidated characteristic value.

As such, the interdependency of the characteristics of the application may be analyzed for refining the (derived) characteristics value. Based on the data availability, inter-dependency rules may be applied to adjust the characteristics value. The refined tuned characteristic value may be updated manually before the analysis for the best-fit approach selection. Some example relations between the characteristics may be as follows:
Nil: when there is no dependency between the characteristics;
Positive: when there is a positive impact on the characteristic;
Negative: when there is a negative impact on the characteristic;
Level (High/Medium/Low.): based on the level of impact.

It should be noted that the dependency relation may not be commutative. For example, the application with high “legacy platform dependency” may mean that “Cloud-readiness issues of application” also may be “high”. Further, “Cloud-readiness issues of application” being “high” may not always mean the application has high “legacy platform dependency.” An example characteristics dependency matrix is illustrated as Table-5 in FIG. 7.

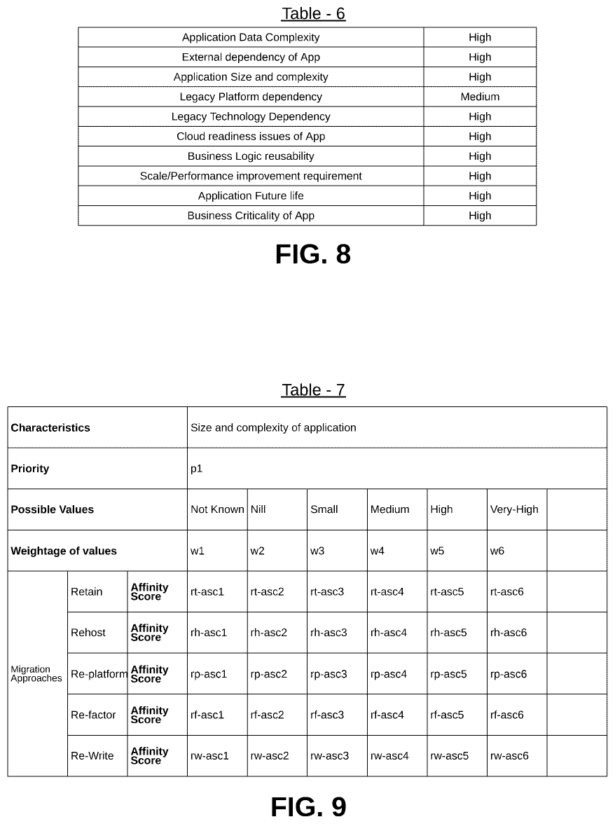

Accordingly, for each characteristic of the set of characteristics, the consolidated characteristic value may be refined based on an inter-relationship of the characteristic with remaining of the set of characteristics, to obtain a refined consolidated characteristic value. The plurality of characteristics and their refined consolidated score are collated in Table-6 illustrated in FIG. 8 (with reference to Table-4).

It should be noted that characteristics may influence the migration approach decision making in multiple ways. For example, if the expected future life of application is small, approach “retain” may be the only feasible migration approach, and the other migration approaches may not be considered. For mission critical applications, the “rewrite” or “refactor” migration approaches may be more feasible, if it is in legacy technology and facing performance and scalability issues. Further, for higher platform dependency, the “re-platform” or “refactor” or “rewrite” migration approaches may be preferred, but subjected to other characteristics. Furthermore, for higher cloud readiness issues, the “re-write” or “refactor” or “re-platform” migration approaches may be preferred. Also, “rehost” migration approaches may be an optimal approach but may depend on other characteristics.

In some embodiments, priory of the characteristics may vary based on the type of application and the context of the business. For example, for some applications, performance improvement and scalability may be of high priority. Further, the factor of weightage of the characteristics value may impact the selection of the migration approach. For example, if the characteristic “future life of the application” is very small, then the characteristic “future life of the application” may have high weightage in deciding the “Retain” migration approach. Similarly, if the value of the characteristic “future life of the application” is “high”, then the associated weightage may be low, because recommended migration approach may be based on other characteristics of the application.

For each characteristic, the priority and weightage may be determined. Further, priority and weightage may be determined based on the industrial standard, and may be overridden according to the business context and also re-adjusted through self-learning mechanism.

The affinity-priority value and affinity-weightage value obtaining module 206 may be configured to obtain an associated affinity-priority value and an associated affinity-weightage value corresponding to an associated parameters value, for each of the plurality of parameters associated with the monolith application and for each characteristic of the set of characteristics. The associated affinity-priority value and the affinity-associated affinity weightage value corresponding to the associated parameters value may be predetermined.

The affinity score of a characteristic value to a migration approach may be defined based on: an influence of the characteristics value in the approach compared to other characteristics, and an influence on the characteristic value in the given approach compared to the other approaches. For the characteristic “size and complexity of application”, some example affinity scores to the different migration approaches (i.e. “retain”, “rehost”, “re-platform”, “re-factor”, and “re-wrote”) are collated in Table-7 illustrated in FIG. 9.

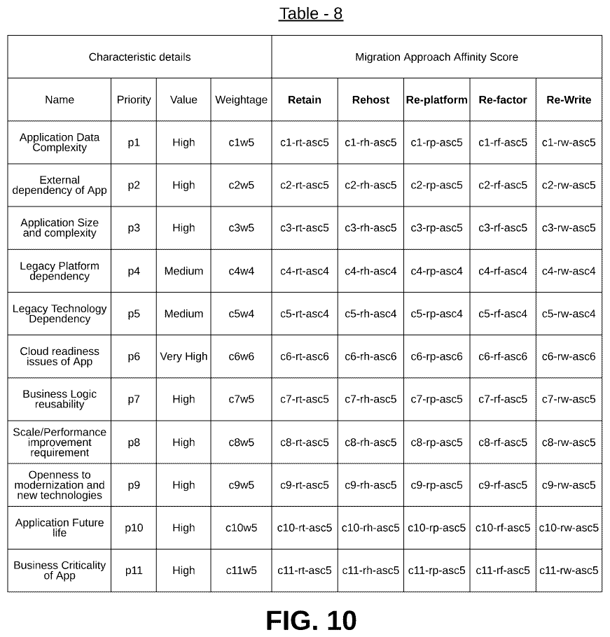

The migration score calculating module 208 may be configured to calculate a migration score based on the consolidated characteristic value, the associated priority value, and associated affinity weightage value, for each of a set of migration approaches. In other words, the migration approach score may be calculated by grouping the characteristic value affinity score corresponding to the application characteristics. Some example migration approach scores for different characteristics for a given application are collated in Table-8 illustrated in FIG. 10.

A migration approach score of a migration approach (Ri) may be calculated as below:

$$Migration \text{-} Score ( Ri ) = sum of ( characteristic \text{-} Priority * Characteristic \text{-} value \text{-} Weightage * Characteristic \text{-} value \text{-} affinity \text{-} score for Ri )$$

With reference to Table-8, for “retain” migration approach, the migration score may be calculated as below:

$$Migration \text{-} Score ( Retain ) = p 1 * c 1 w 5 * c 1 - rt - asc 5 + p 2 * c 2 w 5 * c 2 - rt - asc 5 + p 3 * c 3 w 5 * c 3 - rt - asc 5 + p 4 * c 4 w 4 * c 4 - rt - asc 4 + p 5 * c 5 w 4 * c 5 - rt - asc 4 + p 6 * c 6 w 6 * c 6 - rt - asc 6 + p 7 * c 7 w 5 ** c 7 - rt - asc 5 + p 8 * c 8 w 5 * c 8 - rt - asc 5 + p 9 * c 9 w 5 * c 9 - rt - asc 5 + p 10 * c 10 w 5 * c 10 - rt - asc 5 + p 11 * c 11 w 5 * c 11 - rt - asc 5$$

Therefore, the migration approach score for all the other approaches may be calculated in a similar way as above.

The migration approach affinity scores of an application could like as follows. In particular, a migration approach score (s1) for “retain” migration approach, a migration approach score (s2) for “rehost” migration approach, a migration approach score (s3) for “re-platform” migration approach, a migration approach score (s4) for “re-factor” migration approach, and a migration approach score (s5) for “re-write” migration approach may be calculated.

In some embodiments, the migration score calculating module 208 may be further configured to refine the migration approach score for the directly influencing parameters or characteristics. As such, the migration approach scores derived through application characteristics may be refined through the parameters that directly impact the migration approach. For example, if the application is a COTS or third-party application, it cannot be selected for “re-platform”, “re-factor”, or “re-write” migration approach. Hence, if the application is not cloud-native and not recommended for “rehost” migration approach, then, irrespective of the characteristics, it should be retained or re-placed with another application.

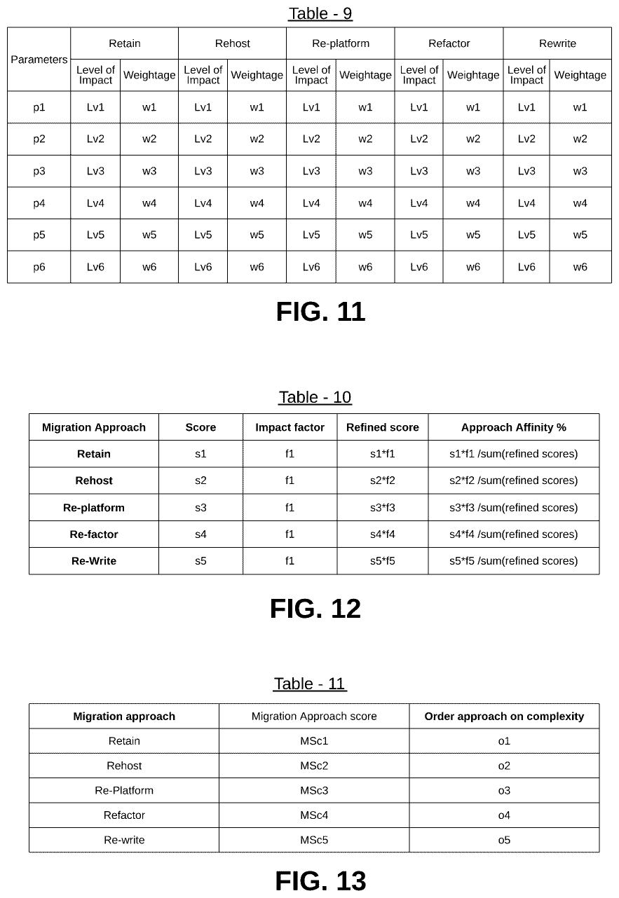

For each parameter, a level of impact on the migration approach and weightage for that migration approach may be defined, as shown in Table-9 illustrated in FIG. 11. For example, level of impact may range from 0 to 5 (0 means not applicable, and 5 means very high impact). Further, the weightage may range from 1 to 10.

The migration score calculating module 208 may further calculate the impact score of the application. For example, the impact score of the application may be calculated as:

$$Direct impact factor = sum ( weightage * Level of Impact )$$

Accordingly, the refined approach score for the application may be calculated for all the migration approaches, as collated in Table-10 illustrated in FIG. 12.

It should be noted that in some scenarios a single migration approach may not be completely applicable for the application. The scores as shown in Table-10 indicate the affinity of the application towards the migration approach based on its characteristics. This scoring approach helps to plan the migration process holistically. Further, the estimation and further wave planning of the migration execution may be performed with higher predictability.

The relevant migration approach selecting module 210 may be configured to select a relevant migration approach from the set of migration approaches, based on the migration approach score for each of the set of migration approaches. As such, for each of the set of migration approaches, an associated impact value may be obtained, for each of the plurality of parameters, and an impact-affinity score may be calculated based on the migration approach score and the associated impact value. Further, a relevant migration approach may be selected from the set of migration approaches, based on the impact-affinity score for each of the set of migration approaches.

It should be noted that selection of the migration approach with the highest score may not always be the best fit approach. To identify the best fit migration approach, the migration approaches may be ordered based on their complexity in implementation. To identify the best fit migration approach, an order of the migration approaches may be determined. The order of the migration approaches may be determined as follows:

$$Order ( Best \text{-} fit \text{-} Approach ) = sum ( score * order ) / sum ( score )$$

An example order approach is collated in Table-11 as illustrated in FIG. 13. From the order, the associated migration approach may be identified as the best fit migration approach based on the application characteristic. As such, with this process, the best fit approach of the application with respect to migration may be identified. The affinity score may highlight the level of affinity of the application with specific approach for efficient planning of the migration.

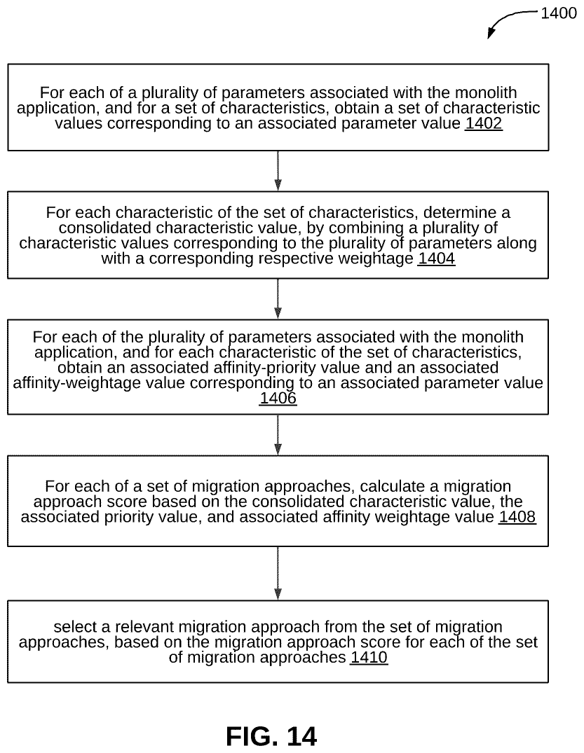

Referring now to FIG. 14, a flowchart of a method 1400 of identifying migration approach for a monolith application is illustrated, in accordance with some embodiments. For example, the method 1400 may be performed by the approach identifying device 102 or the processor 110 of the approach identifying device 102.

At step 1402, for each of a plurality of parameters associated with the monolith application and for a set of characteristics, a set of characteristic values may be obtained corresponding to an associated parameters value. The associated parameters value corresponding to the associated parameters may be predetermined. In some embodiments, in order to obtain the parameter value, attribute data associated with the monolith application may be analyzed, and the associated parameter value may be determined based on the analyzing. Determining the associated parameter value may include selecting a relevant associated parameter value from a plurality of selectable associated parameter values, based on the analyzing. The characteristic value may be obtained upon referring a predefined mapping directory.

At step 1404, for each characteristic of the set of characteristics, a consolidated characteristic value may be determined, by combining a plurality of characteristic values corresponding to the plurality of parameters along with a corresponding respective weightage. In some embodiments, in order to determine the consolidated characteristic value, one or more characteristics from the set of characteristics may be grouped together into a plurality of groups based on the set of characteristic values. Further, for each group of the plurality of groups, a consolidated group characteristic value may be determined, by combining characteristic values corresponding to the characteristics associated with the group, along with corresponding respective characteristic-weightages, to further determine an order value. Furthermore, for each characteristic of the set of characteristics, a revised consolidated characteristic value may be determined, based on the order value determined for each group of the plurality of groups.

In some embodiments, determining the consolidated characteristic value may further include refining (for each characteristic of the set of characteristics) the consolidated characteristic value based on an inter-relationship of the characteristic with remaining of the set of characteristics, to obtain a refined consolidated characteristic value.

At step 1406, for each of the plurality of parameters associated with the monolith application, and for each characteristic of the set of characteristics, an associated affinity-priority value and an associated affinity-weightage value corresponding to an associated parameters value may be obtained. The associated affinity-priority value and the affinity-associated affinity weightage value corresponding to the associated parameters value may be predetermined.

At step 1408, for each of a set of migration approaches, a migration approach score may be calculated based on the consolidated characteristic value (or the refined consolidated characteristic value), the associated priority value, and associated affinity weightage value.

At step 1410, a relevant migration approach may be selected from the set of migration approaches, based on the migration approach score for each of the set of migration approaches. In some embodiments, in order to select a relevant migration approach, for each of the set of migration approaches, an associated impact value may be obtained, for each of the plurality of parameters. Further, an impact-affinity score may be calculated based on the migration approach score and the associated impact value, and a relevant migration approach may be selected from the set of migration approaches, based on the impact-affinity score for each of the set of migration approaches.

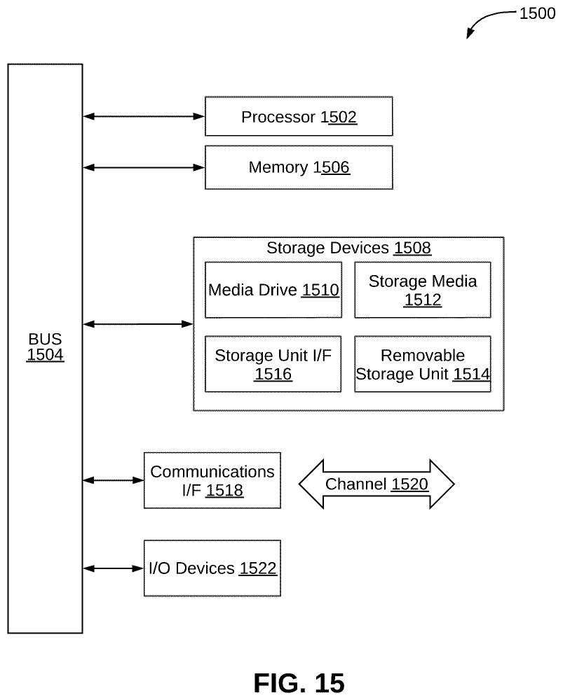

Referring now to FIG. 15, an exemplary computing system 1500 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 1500 may represent, for example, a user device such as a desktop, a laptop, a mobile phone, personal entertainment device, DVR, and so on, or any other type of special or general-purpose computing device as may be desirable or appropriate for a given application or environment. The computing system 1500 may include one or more processors, such as a processor 1502 that may be implemented using a general or special purpose processing engine such as, for example, a microprocessor, microcontroller or other control logic. In this example, the processor 1502 is connected to a bus 1504 or other communication media. In some embodiments, the processor 1502 may be an Artificial Intelligence (AI) processor, which may be implemented as a Tensor Processing Unit (TPU), or a graphical processor unit, or a custom programmable solution Field-Programmable Gate Array (FPGA).

The computing system 1500 may also include a memory 1506 (main memory), for example, Random Access Memory (RAM) or other dynamic memory, for storing information and instructions to be executed by the processor 1502. The memory 1506 also may be used for storing temporary variables or other intermediate information during the execution of instructions to be executed by processor 1502. The computing system 1500 may likewise include a read-only memory (“ROM”) or other static storage device coupled to bus 1504 for storing static information and instructions for the processor 1502.

The computing system 1500 may also include storage devices 1508, which may include, for example, a media drive 1510 and a removable storage interface. The media drive 1510 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 1512 may include, for example, a hard disk, magnetic tape, flash drive, or other fixed or removable media that is read by and written to by the media drive 1510. As these examples illustrate, the storage media 1512 may include a computer-readable storage medium having stored therein particular computer software or data.

In alternative embodiments, the storage devices 1508 may include other similar instrumentalities for allowing computer programs or other instructions or data to be loaded into the computing system 1500. Such instrumentalities may include, for example, a removable storage unit 1514 and a storage unit interface 1516, such as a program cartridge and cartridge interface, a removable memory (for example, a flash memory or other removable memory module) and memory slot, and other removable storage units and interfaces that allow software and data to be transferred from the removable storage unit 1514 to the computing system 1500.

The computing system 1500 may also include a communications interface 1518. The communications interface 1518 may be used to allow software and data to be transferred between the computing system 1500 and external devices. Examples of the communications interface 1518 may include a network interface (such as an Ethernet or other NIC card), a communications port (such as for example, a USB port, a micro-USB port), Near field Communication (NFC), etc. Software and data transferred via the communications interface 1518 are in the form of signals which may be electronic, electromagnetic, optical, or other signals capable of being received by the communications interface 1518. These signals are provided to the communications interface 1518 via a channel 1520. The channel 1520 may carry signals and may be implemented using a wireless medium, wire or cable, fiber optics, or other communications medium. Some examples of the channel 1520 may include a phone line, a cellular phone link, an RF link, a Bluetooth link, a network interface, a local or wide area network, and other communications channels.

The computing system 1500 may further include Input/Output (I/O) devices 1522. Examples may include, but are not limited to a display, keypad, microphone, audio speakers, vibrating motor, LED lights, etc. The I/O devices 1522 may receive input from a user and also display an output of the computation performed by the processor 1502. In this document, the terms “computer program product” and “computer-readable medium” may be used generally to refer to media such as, for example, the memory 1506, the storage devices 1508, the removable storage unit 1514, or signal(s) on the channel 1520. These and other forms of computer-readable media may be involved in providing one or more sequences of one or more instructions to the processor 1502 for execution. Such instructions, generally referred to as “computer program code” (which may be grouped in the form of computer programs or other groupings), when executed, enable the computing system 1500 to perform features or functions of embodiments of the present invention.

In an embodiment where the elements are implemented using software, the software may be stored in a computer-readable medium and loaded into the computing system 1500 using, for example, the removable storage unit 1514, the media drive 1510 or the communications interface 1518. The control logic (in this example, software instructions or computer program code), when executed by the processor 1502, causes the processor 1502 to perform the functions of the invention as described herein.

One or more techniques for identifying migration approach for migration of a monolith application are disclosed. the above techniques provide for efficient migration planning for the monolith application. Further, the techniques enable documentation of the monolith applications.

It is intended that the disclosure and examples be considered as exemplary only, with a true scope and spirit of disclosed embodiments being indicated by the following claims.

We claim:

1. A method of identifying migration approach for a monolith application, the method comprising:
for each of a plurality of parameters associated with the monolith application, and for a set of characteristics, obtaining a set of characteristic values corresponding to an associated parameter value, wherein the associated parameter value corresponding to the associated parameter is predetermined;
for each characteristic of the set of characteristics, determining a consolidated characteristic value, by combining a plurality of characteristic values corresponding to the plurality of parameters along with a corresponding respective weightage;
for each of the plurality of parameters associated with the monolith application, and for each characteristic of the set of characteristics, obtaining an associated affinity-priority value and an associated affinity-weightage value corresponding to an associated parameter value, wherein the associated affinity-priority value and the affinity-associated affinity weightage value corresponding to the associated parameter are predetermined;
for each of a set of migration approaches, calculating a migration approach score based on the consolidated characteristic value, the associated priority value, and associated affinity weightage value; and
selecting a relevant migration approach from the set of migration approaches, based on the migration approach score for each of the set of migration approaches.

2. The method as claimed in claim 1, further comprising:
analyzing attribute data associated with the monolith application; and
determining the associated parameter value based on the analyzing, wherein determining the associated parameter value comprises:
selecting a relevant associated parameter value from a plurality of selectable associated parameter values, based on the analyzing.

3. The method as claimed in claim 1, wherein the characteristic value is obtained from a predefined mapping directory.

4. The method as claimed in claim 1, wherein determining the consolidated characteristic value comprises:
grouping together one or more characteristics from the set of characteristics into a plurality of groups based on the set of characteristic values;
for each group of the plurality of groups, determining a consolidated group characteristic value, by combining characteristic values corresponding to the characteristics associated with the group, along with corresponding respective characteristic-weightages, to further determine an order value; and
for each characteristic of the set of characteristics, determining a revised consolidated characteristic value, based on the order value determined for each group of the plurality of groups.

5. The method as claimed in claim 4, wherein determining the consolidated characteristic value further comprises:
for each characteristic of the set of characteristics, refining the consolidated characteristic value based on an inter-relationship of the characteristic with remaining of the set of characteristics, to obtain a refined consolidated characteristic value.

6. The method as claimed in claim 1, further comprising:
for each of the set of migration approaches,
obtaining an associated impact value, for each of the plurality of parameters; and
calculating an impact-affinity score based on the migration approach score and the associated impact value; and
selecting a relevant migration approach from the set of migration approaches, based on the impact-affinity score for each of the set of migration approaches.

7. A system for identifying migration approach for a monolith application, the system comprising:
a processor;
a memory communicatively coupled to the processor, the memory storing a plurality of processor-executable instructions, wherein the processor-executable instructions, upon execution by the processor, cause the processor to:
for each of a plurality of parameters associated with the monolith application, and for a set of characteristics, obtain a set of characteristic values corresponding to an associated parameter value, wherein the associated parameter value corresponding to the associated parameter is predetermined;
for each characteristic of the set of characteristics, determine a consolidated characteristic value, by combining a plurality of characteristic values corresponding to the plurality of parameters along with a corresponding respective weightage;
for each of the plurality of parameters associated with the monolith application, and for each characteristic of the set of characteristics, obtain an associated affinity-priority value and an associated affinity-weightage value corresponding to an associated parameter value, wherein the associated affinity-priority value and the affinity-associated affinity weightage value corresponding to the associated parameter are predetermined;
for each of a set of migration approaches, calculate a migration approach score based on the consolidated characteristic value, the associated priority value, and associated affinity weightage value; and
select a relevant migration approach from the set of migration approaches, based on the migration approach score for each of the set of migration approaches.

8. The system as claimed in claim 6, wherein determining the consolidated characteristic value comprises:
grouping together one or more characteristics from the set of characteristics into a plurality of groups based on the set of characteristic values;
for each group of the plurality of groups, determining a consolidated group characteristic value, by combining characteristic values corresponding to the characteristics associated with the group, along with corresponding respective characteristic-weightages, to further determine an order value; and
for each characteristic of the set of characteristics, determining a revised consolidated characteristic value, based on the order value determined for each group of the plurality of groups.

9. The system as claimed in claim 7, wherein determining the consolidated characteristic value further comprises:
for each characteristic of the set of characteristics, refining the consolidated characteristic value based on an inter-relationship of the characteristic with remaining of the set of characteristics, to obtain a refined consolidated characteristic value.

10. The system as claimed in claim 7, wherein the processor-executable instructions, upon execution by the processor, cause the processor to:
for each of the set of migration approaches,
obtain an associated impact value, for each of the plurality of parameters; and
calculate an impact-affinity score based on the migration approach score and the associated impact value; and
select a relevant migration approach from the set of migration approaches, based on the impact-affinity score for each of the set of migration approaches.
